(19) United States
(12) Patent Application Publication
(10) Pub. No.: US 2019/0027791 A1
(43) Pub. Date: Jan. 24, 2019

(54) BATTERY MODULE WITH ORIENTATION DETECTION FOR ALTERNATE OPERATIVE STATES

(71) Applicant: Elitise LLC, Tucson, AZ (US)

(72) Inventors: Sergei Begliarov, Tucson, AZ (US); Juan L. Yanez, Tucson, AZ (US); Tony D. Bleak, Tucson, AZ (US); Kagum G. Zakharyan, Tucson, AZ (US); Frank J. Napolez, Tucson, AZ (US)

(73) Assignee: ELITISE LLC, Tucson, AZ (US)

(21) Appl. No.: 16/137,948

(22) Filed: Sep. 21, 2018

Related U.S. Application Data
(63) Continuation of application No. PCT/US17/25293, filed on Mar. 31, 2017.
(60) Provisional application No. 62/315,872, filed on Mar. 31, 2016.

(51) Int. Cl. H01M 10/42; H01M 10/48; H02J 7/00

(52) U.S. Cl. CPC H01M 10/4257; H01M 2010/4271; H02J 7/0021; H01M 10/48

(57) ABSTRACT

A battery module architecture including a power source is controlled by orientation detection and enablement circuit to recognize physical orientations of the battery module and transition between alternate operative states based on the battery module physical orientation.

### FIELD OF THE INVENTION

The present invention relates to battery module architectures that facilitate alternate operative states depending on the physical orientation of the battery module.

### SUMMARY OF THE INVENTION

The present disclosure includes improvements to battery module control circuit architectures to enhance the functionality, safety and battery life of batteries. Features of the resulting battery architecture are adaptable to past and present battery chemistries, such as Lead-Acid and Lithium, and finds particular utility in battery modules intended as substitutes for lead-acid based battery modules.

The invention may be characterized as a control circuit for a power source in a battery module housing that may have different operating states when positioned in a first and a second physical orientation, respectively. The battery module may comprise a negative power terminal and a positive power terminal that each penetrate and conduct power through the housing, a contactor having first and second contactor terminals and a contactor control terminal. One of the contactor terminals may be coupled between the power source and at least one of the negative or positive power terminals, and an orientation detection and enablement circuit that includes a CPU and an orientation detection component selected from accelerometers, gyroscopes, and magnetometers or a combination thereof, has an interrupt output and an orientation data output to produce an interrupt output upon detection of the housing in the second physical orientation, and the CPU has an orientation data input and a contactor enable output, the CPU orientation data input coupled to the orientation data output and the contactor enable output coupled to the contactor control terminal, respectively. The CPU may be a microprocessor or microcontroller and may process data received on the orientation data output to interpret and confirm or correct detected first or second orientations by comparison against data stored in memory or by mathematical operation or by a combination thereof. The invention may be further characterized as having one or more low-power states facilitated by exploitation of the capabilities of wake/sleep modes of the CPU or microprocessor or enabled by system configuration of voltage source switches, voltage switch logic in control thereof, an at least one output from an orientation detection device.

The invention may also be characterized as a method of controlling a battery module when transitioning from a first orientation to a second orientation. The method may include or comprise monitoring the orientation of the battery housing with an orientation detection component, detecting a change in the orientation of the battery housing in the first orientation and generating an interrupt signal, waking a CPU, confirming that the battery housing is in the second orientation, and closing a contactor coupled between at least one battery cell in the battery module and either a positive or negative terminal of the battery module.

Numerous other advantages and features of the present invention will become readily apparent from the following description of the invention and the embodiments thereof, from the claims and from the accompanying drawings.

### BRIEF DESCRIPTION OF THE DRAWINGS

The objects, features and advantages of the present invention will be more readily appreciated upon reference to the following disclosure when considered in conjunction with the accompanying drawings, wherein like reference numerals are used to identify identical components in the various views.

FIG. 1 illustrates an embodiment of a battery module 100 incorporating aspects of the present description, including a first orientation that corresponds to a storage mode orientation wherein the voltage and current between the battery housing positive terminal 104 and the battery housing negative terminal 105 is zero or negligible;

FIG. 2 illustrates a bi-directional current sensing circuit 300 for a battery module 100 control circuit;

FIG. 3 illustrates an embodiment of the control circuit of the battery module 100 with some of the components of an orientation detection and enablement circuit that enables features described herein;

FIG. 4 illustrates additional components of the battery module 100 control system orientation detection and enablement circuit including an orientation detection component in the form of a 3-axis accelerometer 370, and one or more voltage source switches 390, and a voltage source switch control 380;

FIG. 5 illustrates another embodiment of the control circuit wherein the voltage source switches 390 are combined and controlled by the voltage source switch control logic 380; and

FIG. 6 illustrates an embodiment incorporating a motion sensor or gyroscope 400 together with the accelerometer 370.

### DESCRIPTION OF PREFERRED EMBODIMENTS

The invention described is adaptable to embodiments having many different forms and functions related to the disclosure herein. The embodiment shown in the drawings and will be described herein in detail with the understanding that the present disclosure is to be considered as an exemplification of the principles of the invention and is not intended to limit the invention to the specific embodiment(s) illustrated. Systems consistent with the present invention may be alternately embodied, practiced, and/or carried out in various ways or implementations. Also, it is to be understood that the phraseology and terminology employed herein, as well as the abstract included below, are for the purposes of description and should not be regarded as limiting. Reference throughout this specification to “embodiment” should inform a person having ordinary skill that a particular feature, structure, or characteristic described in connection with the embodiment is included in at least one embodiment of the present invention but not necessarily in all embodiments. The features, structures, or characteristics of any embodiment of the present invention may be combined in any suitable manner and in any suitable combination with one or more other embodiments, including the use of selected features without corresponding use of other features. Modifications may be made to adapt an implementation of certain features to the essential scope and spirit of the present invention and certain features, limitations, or elements of each embodiment can be omitted or replaced with equivalents. It should be understood that other variations and modifications of the embodiments of the present invention described and illustrated herein are possible and part of the spirit and scope of the present invention. Finally, the disjunctive term “or” herein, is generally intended to mean “and/or”, having both conjunctive and disjunctive meanings (i.e. not an “exclusive or” meaning), unless so indicated. And, as used in the description herein and throughout the claims that follow, “a”, “an”, and “the” should be interpreted as “at least one” and include plural references unless the context dictates otherwise.

As one example of an implementation or embodiment, aspects of this disclosure are adapted to construct alternate battery module 100 embodiments that may each be appropriate for specific or general applications. Therefore, the description of a particular or preferred battery module 100 herein is not intended to limit the scope of this or any related patent application or claim therein that follows or claims benefit of this patent application. The figures and description herein describe an embodiment of a battery module 100 having components and software processes to detect alternate physical orientations of the battery module 100 and alter the operational state of the battery module 100 as a result thereof. The battery module 100 may be characterized as having several or N possible distinct physical orientations and have at least two alternate operating states (and possibly more); with each operating state depending on the detected physical orientation of the battery module 100. At least one such detected physical orientation or a change thereto may be associated in system configuration or programming with a first operative state, at least another detected physical orientation or a change thereto, may be associated with at least another operative state. Further, yet another detected physical orientation or change thereto, may be associated with another or third operative state, and so on until there are no remaining battery module 100 operating states or distinguishable and detectable physical orientations. Each operating state may depend on a detected static or dynamic physical orientation of the battery module 100 and a battery module 100 may have at least two alternate operating states that each depend on the detection of static physical orientations of the battery module 100, detected dynamic physical orientations of the battery module 100, or the detected combinations or sequences of static physical or dynamic orientations or combinations thereof. Finally, it is also contemplated that one or more battery module 100 operative states may be associated with the inability of system components to detect any single distinct physical orientation.

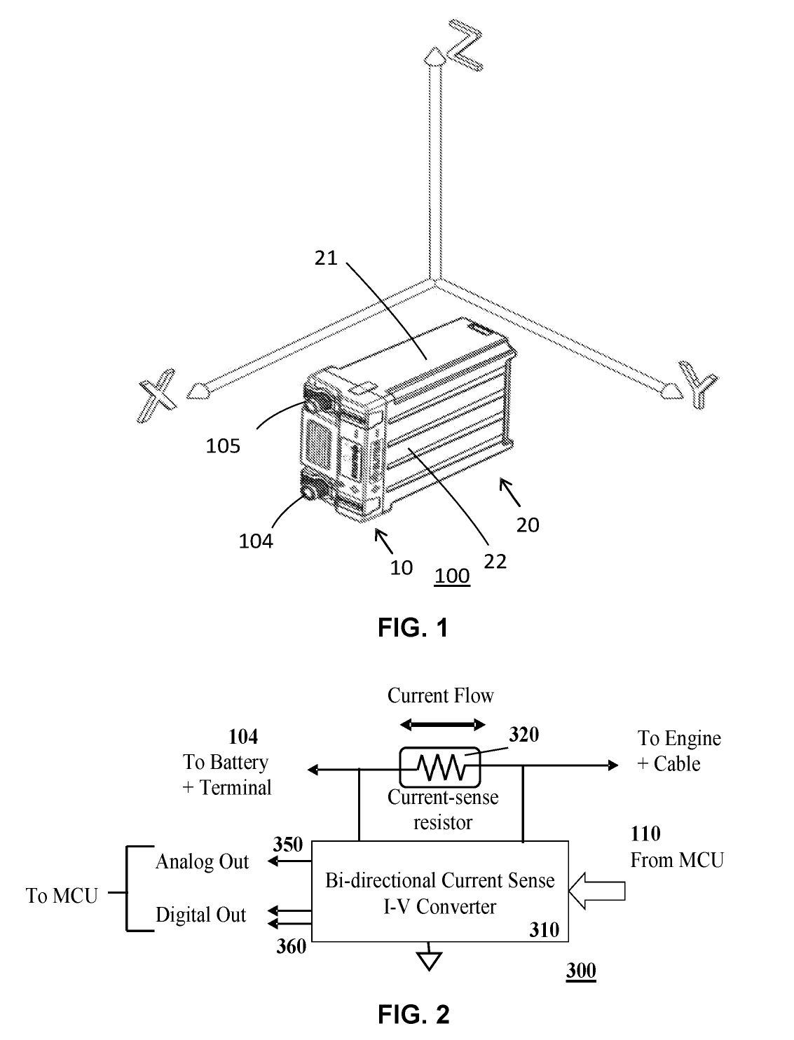

While alternative battery module 100 housing design choices may engender alternate or similar constraints, a preferred and practical implementation of a battery module 100 enabled as described herein is reflective of the battery module 100 housing design choice, the capability of technology to detect and differentiate between the several possible physical orientations, and the software processes or programming that interpret or process orientation detection data and instructs system components initiate or maintain the battery module 100 operative state. FIG. 1 illustrates a preferred and practical embodiment implementing or enabling aspects of the features described and is comprised of a battery module 100 having six surfaces upon which the battery module 100 may rest in a static position, alone or without additional structural support. The six surfaces comprise substantially flat resting surfaces and include a battery module top portion 10, first and second housing side walls 22, first and second housing end walls 21, and a housing bottom wall portion 23 (not shown).

It is preferred that at least one, but possibly several detected physical orientation(s) of the battery module 100 may be associated with at least a first operative state. As an example, the battery module 100 illustrated may have as many as N=6 detectable physical orientations that each correspond to a directional axis that is orthogonal to two other axis having a positive and negative portions (i.e. +x, −x, +y, −y, +z, −z). Further an orientation detection and enablement circuit having at least one physical orientation detection component is included within the battery module 100 that provides an orientation data output that changes depending on the battery module 100 physical orientation and wherein a particular orientation data output, or set or range of physical orientation data outputs, is associated within system processor programming with a first operative state, and at least a second physical orientation data output, or range of second orientation data outputs, is associated within system processor programming with a second operative state. The generation of physical orientation data output(s) may be by one or more physical orientation detection components with the understanding that different hardware and software combinations may implement the battery module 100 described and that alternate implementation are considered with the scope of this disclosure. The description of one such preferred system should not be interpreted as limiting the disclosure or claims to the particular embodiments described herein.

The battery module 100 includes orientation detection and enablement circuit including at least one physical orientation detection component and system processing and related circuitry that is configured and programmed to detect physical orientation(s) of the battery module 100 and control the operative state of the battery module 100 as a result thereof. That is, the battery module 100 may have different operative states depending on the static or dynamic physical orientation, such as whether a detected static or dynamic physical orientation is the same or different from a previous detected orientation, or even whether the battery module 100 and the physical orientation detection component therein cannot detect a static or dynamic physical orientation. A first embodiment of a battery module 100 having capabilities described herein includes at least first and second operative states wherein each operative state may be automatically enabled or require additional confirmation from outside the battery module 100 before being enabled.

A first operative state is characterized as an essentially “zero power”, state in which the battery module 100 presents a negligible or zero voltage potential between the battery module terminals, 104 and 105, and the battery housing positive terminal 104 is prevented from sourcing current to external loads (but may when specifically enabled, sink current to charge the battery cells 101). Conversely, a second operative state may provide a power level between the battery module terminals (104 and 105) that is sufficient for delivering sustained power to external loads, such as for example an external vehicle load containing an electric starter motor and an alternator. In the preferred embodiment the second operative state voltage level between the battery module terminals (104 and 105) corresponds to at least about 70%, but preferably at least about 85%, of the accumulated battery module voltage 102. Or, the second operative state may correspond to a lower voltage that is less than that required to initiate or sustain an engine start event but yet sufficient to power engine accessory electronics. As an example, the lower voltage may correspond to a voltage that does not exceed 65% of the accumulated battery module voltage 102 but is preferably less than 55% of the accumulated battery module voltage 102. The capability of the first operative state provides for safe storage or transport of battery modules 100 and second operative states permit either vehicle starts and/or vehicle accessory power for standard battery operations, respectively. It is noted that the first or second operative state may be automatically triggered by one or more physical orientation data output(s) and system electronics interpretation thereof, or also conditionally dependent on inputs from other battery module 100 system electronics, vehicle electronics system data, or from external data sources such as a user mobile computing device coupled to the battery module 100 by a wireless link. The option to automatically or conditionally trigger battery module 100 state transitions depends on user design choices and control circuit configuration or programming as described by embodiments herein.

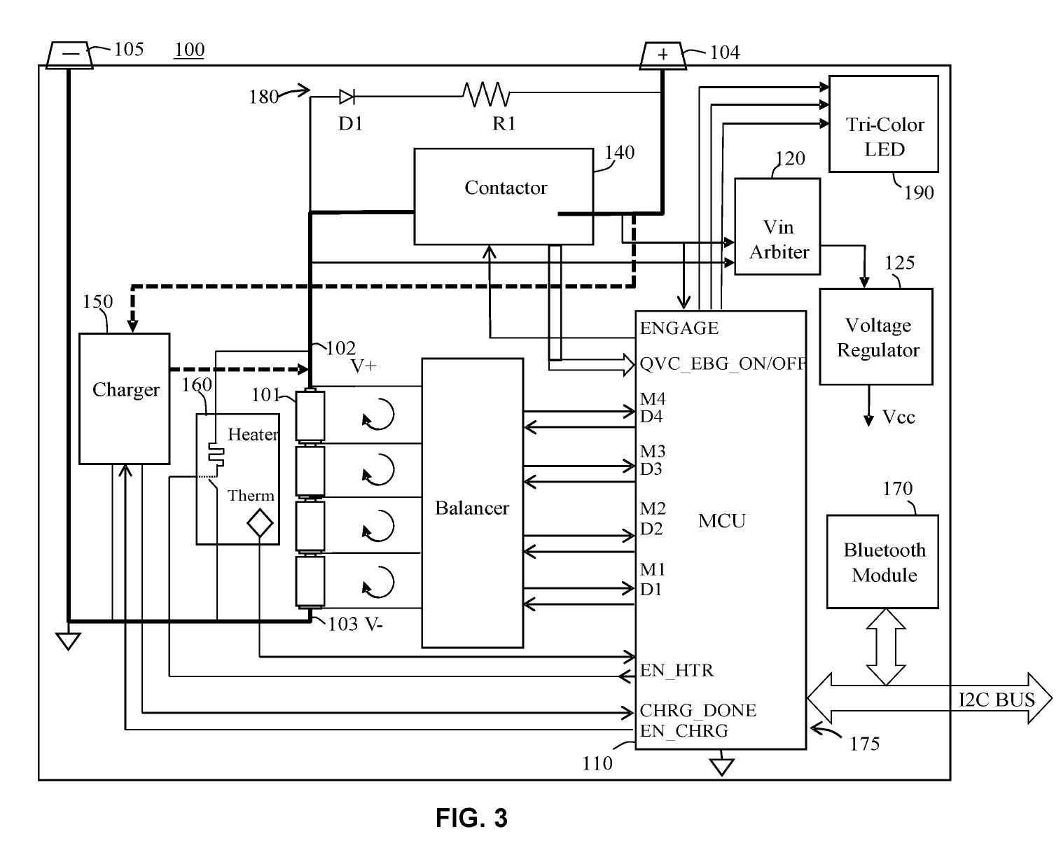

A block diagram of an embodiment of a battery module 100 capable of the features described herein is illustrated in FIGS. 2-5. The preferred battery module 100 comprises a physically sealed battery (referred to herein as a battery module 100) based power source including a plurality of battery cells 101 operatively coupled to subsystems having distinct functions that operate together to provide safe and reliable power from the battery module 100. Power from the battery module 100 is accessed through the battery housing positive terminal 104 and the battery housing negative terminal 105 that each penetrate and conduct electrical current to and from the battery module 100. The plurality of battery cells 101 are coupled electrically to each other in series or “stacked” to accumulate or sum the individual battery cell voltages and create the accumulated battery module voltage 102 that is equivalent to the sum of each of the battery cell 101 minus small power losses from the individual battery cell terminals or any conductive connecters between or leading to and from the first and last battery cells 101. A switch, relay, or solid-state contactor 140 is electrically coupled in series between the battery cells 101 and the positive battery terminal 104 and has a CLOSED state and an OPEN state. When in the CLOSED state the contactor 140 allows current flow between the accumulated battery cell voltage 102 and the positive battery terminal 104 and when in the OPEN state the contactor 140 presents an open circuit or near infinite impedance between the accumulated battery cell voltage 102 and the positive battery terminal 104. Finally, current and voltage at the battery housing positive terminal 104 may be measured or confirmed by a bi-directional current sensing circuit 300 with a current-sense resistor coupled in series with the battery housing positive terminal 104 to sense the magnitude and polarity of voltage potential and current flow to and from the battery module 100, which is indicative of engine or battery module 100 operating states and/or operating state changes. See FIG. 2. At least one of an analog or digital output from the bi-directional current sensing circuit 300 is coupled to the microprocessor 110 which output from the bi-directional current sensing circuit 300 thereon may be used by system programing to independently confirm the operational states of the battery module 100.

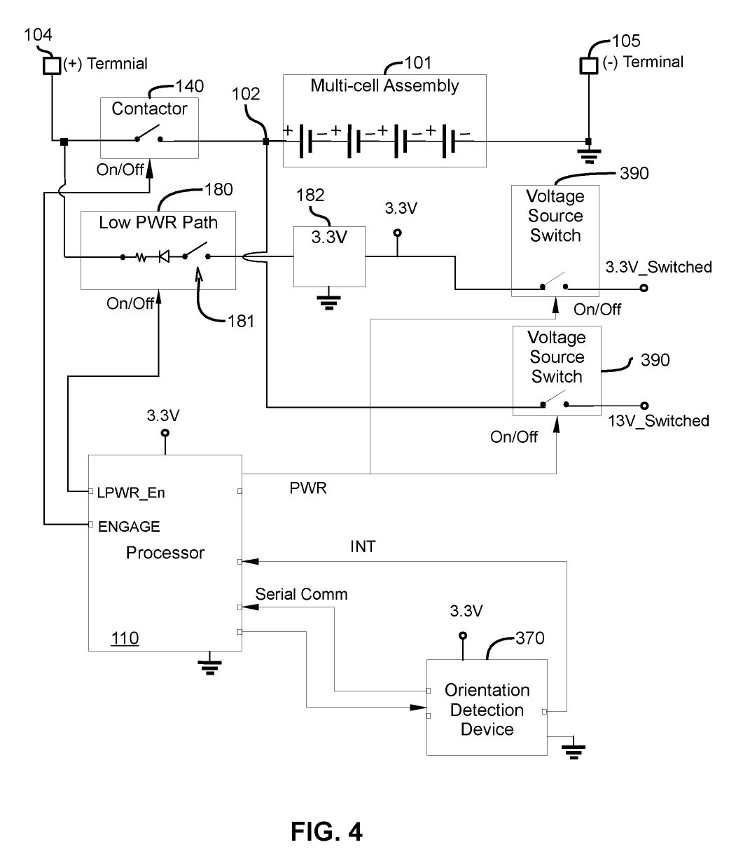

The contactor 140 has a control input that is coupled to an output port of the microprocessor (“ENGAGE”) which is electronically toggled such as with a digital signal to cause the contactor 140 to change states (e.g. change from “CLOSED” to “OPEN”) and cause either an open or closed path between the accumulated battery cell voltage 102 and the positive battery cell terminal 104. The OPEN state of the contactor 140 may enable a safe zero power state such as for: storage or transport; if the battery module 100 is subject to unsafe operating conditions that might damage the battery module 100 components; or if the vehicle in which the battery module 100 is installed subjected to a crash or other emergency event. The contactor 140 OPEN state condition can also be selected based upon receipt of interrupts or other commands that are communicated to the microprocessor 110 from one or more internal components or external or remote wired or wireless transceivers. If however, a non-zero power state is desired (i.e. a low non-zero power level), a low power current path 180 (coupled electrically in parallel to the contactor 140) from the accumulated battery module voltage 102 to the positive battery terminal 104 allows power from the battery module 100 that is sufficient to power external components such as vehicle engine computers and the like while but insufficient to power a vehicle starter load and start a vehicle. An exemplary low current source or path 180 comprises a diode (“D1”) and resistor (“R1”) coupled electrically in series from the accumulated battery module voltage 102 to the positive battery terminal 104 i.e. with the diode anode coupled to the accumulated battery module voltage 102, the diode cathode coupled to a first end of the resistor, and the other end of the resistor coupled to the positive battery terminal 104. A preferred low power current path 180 further includes a low power source 182 such as a three terminal regulator buck regulator with the power input coupled to the accumulated battery module voltage 102 and the output coupled to the resistor of the low power current path 180 as shown in FIGS. 4-6.

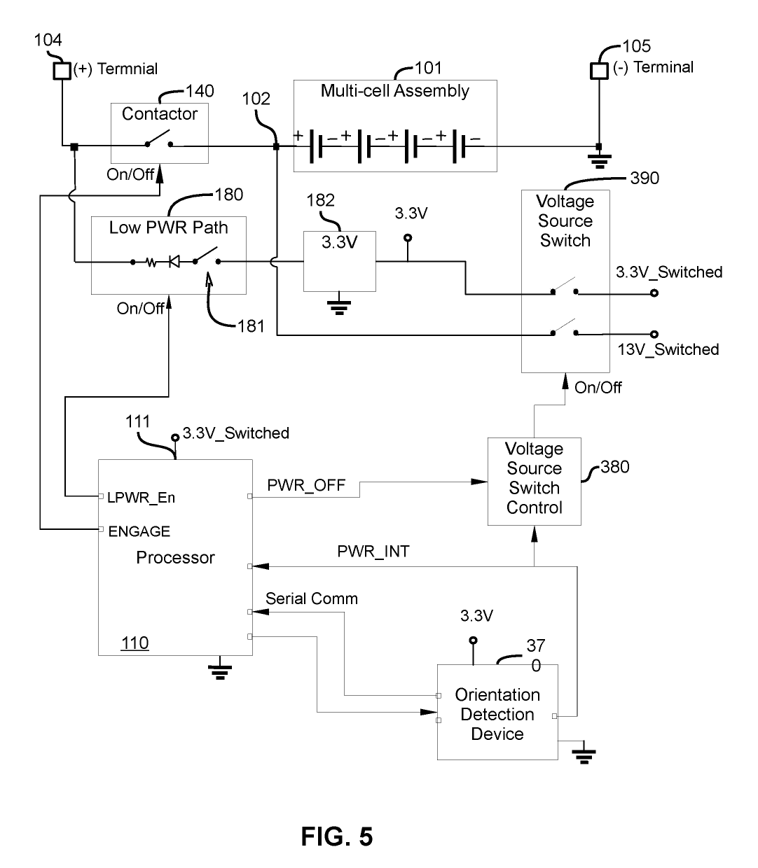

FIG. 4 illustrates a first embodiment including an orientation and detection enablement circuit having an orientation detection component that enables detection of physical orientations of the battery module 100. The orientation detection and enablement circuit of the embodiment includes the microprocessor 110 and at least an accelerometer 370, but preferably also includes a voltage source switch 390, and voltage source switch control logic 380, which enable optional power saving capability of the orientation detection and enablement circuit. FIG. 5 illustrates an alternate embodiment that also includes a motion sensor or gyroscope 400 and a magnetometer or E-compass that provide the orientation detection and enablement circuit with increased accuracy and functionality. It is noted that the orientation and detection enablement circuit may be comprised of an orientation detection component alone but is preferably comprised of a microprocessor and at least one orientation detection component wherein the orientation detection component(s) is(are) selected from accelerometers, gyroscopes, and magnetometers or a combination thereof, with either analog or digital outputs (or both) and with our without a central processing unit (CPU) for integrated processing capability. Further, while the term microprocessor is used herein it is contemplated that embodiments can implement a microcontroller in place of the microprocessor and that the term “processor” and “CPU” includes both microprocessors and microcontrollers.

The battery module 100 of the preferred embodiment is programmed to detect and recognize at least one physical orientation as the storage mode orientation. FIG. 1 for example illustrates a battery module 100 that has been programmed to detect the illustrated orientation as a storage mode orientation. In particular, this embodiment detects and maintains the zero power first operative state if the longer dimensions of the housing bottom wall portion 23 (not shown) and the battery module top portion 10 are aligned substantially in the “z” or vertical direction. This occurs if the battery module 100 is supported on the first housing end walls 21 adjacent the battery housing positive terminal 104 against a resting surface. If in this orientation the battery module 100 embodiment is in a storage mode or first orientation that equates with an open circuit and zero power between the battery module terminals, 104 and 105. If the battery module 100 however is physically oriented in the second physical orientation, the battery module 100 may transition to a second or alternate operative state, such as a full-power operative state with full-power available between battery module terminals, 104 and 105. As one possibility, the battery module 100 may be configured to transition to the second operative state (e.g. a non-zero power state) the battery module 100 it is positioned so that the housing end walls 21 and housing side walls 22 are aligned with or oriented in the “z” or vertical direction, and the housing bottom wall portion 23 makes contact with a supporting surface.

Depending on the implementation of features described herein, the operative state of the battery module 100 in the storage mode may be unalterable absent reorientation of the battery module 100 to a second orientation, or, in embodiments having an alternate implementation of selected features, the microprocessor 110 may wake at timed intervals while in the storage mode to sense the current or voltage conditions at least one of the battery module terminals, 104 and 105, with the bi-directional current sensing circuit 300, detect external charging applied to the battery module 100, or to confirm that the battery module 100 is in any given orientation by receiving data from the orientation detection component output and confirming that the orientation data from the orientation detection component corresponds to the data that is representative of the detected orientation. The microprocessor 110 may confirm that the orientation data corresponds to data that is representative of the detected orientation by a method of comparing the orientation data against orientation data or parameters stored in system memory (such as by lookup table or the like), or by mathematical operations on the orientation data, or by both.

[NOTE: Is there anything patntable about how the microprocessor confirms that the data from the accelerometer corresponds to the storage mode or non-storage mode?]

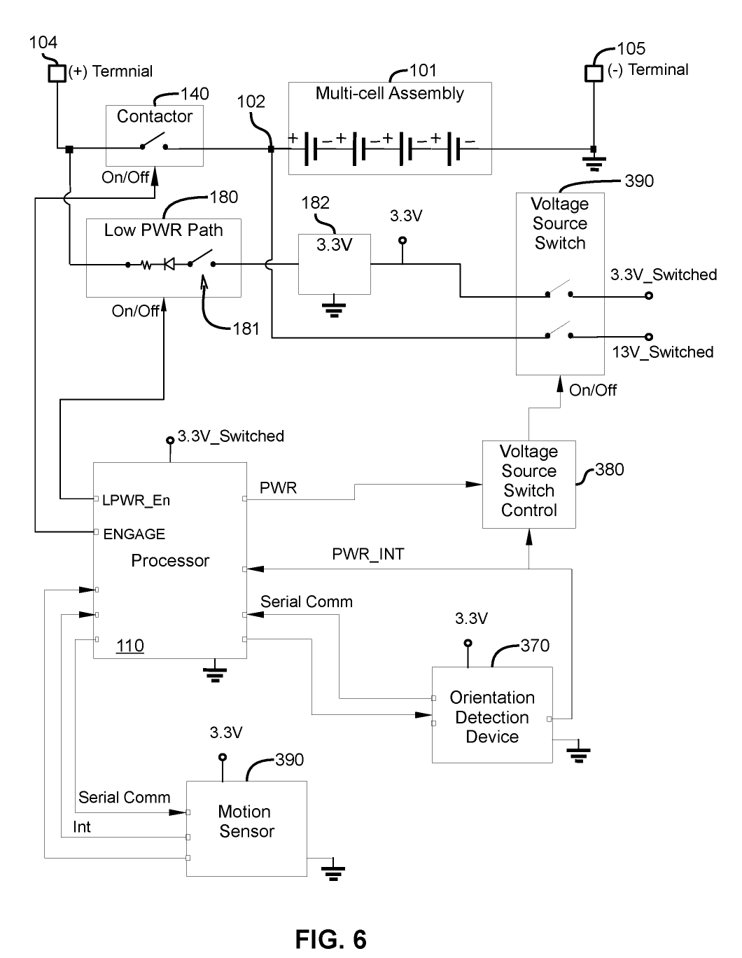

Detections of physical orientations and the initiation of battery module 100 state changes are preferably effected by the accelerometer 370 as illustrated in FIG. 4 or by an accelerometer 370 and gyroscope 400 combination as illustrated in FIGS. 5-6. The physical orientation corresponding to the first orientation or storage orientation, or the physical orientation corresponding to the second orientation or standard use orientation (or the second or any alternate operative state), may be selected and configured during manufacture and assembly or configured by a user by communicating preference instructions from a mobile computing device to components of the orientation detection and enablement circuit via wireless link. Moreover, alternate levels of power saving are capable depending on the implementation of features disclosed herein. In a first implementation, an accelerometer 370 interrupt output (“INT”) and orientation data output (“Serial Comm”) are coupled to the input ports of the microprocessor 110. The accelerometer 370 is (or the accelerometer 370 and gyroscope 400 combination are) configured or programmed to recognize a first orientation as the first operative state or the storage mode orientation and a second orientation as the second operative state or the non-storage mode orientation. Upon detection of the second orientation, the accelerometer 370 interrupt output will alert the microprocessor 110 to receive orientation data output and confirm that the orientation data corresponds to the second orientation and if so, transition the battery module 100 to the second operative state such as by: closing of the contactor 140 (via ENGAGE); by closing voltage source switch control logic 380 (via PWR) to route power to the bi-directional current sensing circuit 300 to sense the voltage and current conditions at the battery module terminals, 104 and 105; or enabling low power current path 180 (via “LPWR_En”). Alternatively, the microprocessor 110 may be configured to be in a low-power mode until it receives the accelerometer 370 interrupt signal, or it may programmed to wake periodically and confirm that the orientation data received by the accelerometer 370 corresponds to the first orientation as reported by the accelerometer 370 interrupt signal and/or close at least one voltage source switch 390 or sense voltage and current conditions at the battery module terminals, 104 and 105, via the bi-directional current sensing circuit 300. Further still, the orientation detection and enablement circuit may be configured as in FIGS. 4-5 wherein the microprocessor 110 of the orientation detection and enablement circuit may be configured to be powered-off until the voltage source switch 390 receives the accelerometer 370 interrupt signal whereupon the voltage source switch 390 closes and routes system power to the microprocessor 110. Again, the microprocessor 110 may programmed to wake periodically and confirm that the orientation data received by the accelerometer 370 corresponds to the first orientation as reported by the accelerometer 370 interrupt signal and/or close at least one voltage source switch 390 and sense voltage and current conditions at the battery module terminals, 104 and 105, via the bi-directional current sensing circuit 300.

Upon confirmation that the battery module 100 is in the second or non-storage mode orientation, the microprocessor 110 will enable the contactor 140 and other components to enable the full-power operative state, or alternatively, another operative state such as a low-power state wherein the low power current path 180 is enabled but the contactor 140 remains in an open state so that the power available at the battery module terminals, 104 and 105, is sufficient to power accessory vehicle electronics but remains insufficient to power a significant load such as a starter motor. The battery module 100 may transition back to a low power state by changing the physical orientation of the battery module 100 to the first or storage mode orientation, whereupon system programming brings the battery module 100 components to a low power or off state in a sequence as determined by system configuration, programming and the capabilities of the components. The microprocessor 110 may then communicate via the communications link to an external computer or smart phone details regarding the state of the battery module 100. Additionally, the bi-directional current sensing circuit 300 may be used to monitor the voltage or current at the battery housing positive terminal 104 and provide independent and additional confirmation that the battery module 100 is in a zero power or low power operative state.

An accelerometer 370 that may be used to enable the features described comprises the Freescale Semiconductor, Inc. MMA8451Q, which is a three-axis, capacitive accelerometer with programmable interrupts used to generate the internal inertial interrupt or wakeup signals that are associated with a battery module 100 being moved from a storage mode orientation to a non-storage mode orientation. The accelerometer 370 includes orientation (portrait/landscape) detection with programmable hysteresis to prevent false detections of changes of physical orientations of the battery module 100. A gyroscope 400 may be combined with the accelerometer 370 to improve the accuracy of physical orientation detection of the battery module 100. An exemplary gyroscope 400 comprises a 3-Axis Digital Angular Rate Gyroscope such as the Freescale Semiconductor, Inc. FXAS21002C. Yet another option is the Freescale FXOS8700CQ, 6-Axis Sensor with Integrated Linear Accelerometer and Magnetometer.

The accelerometer 370 is mountable in the battery module 100 (such as in the battery module top portion 10) on a printed circuit board with the microprocessor 110 and is configured to output data associated with the physical orientation of the battery module 100 to the microprocessor 110, which in turn acts upon the data according to the description herein to alter the operative state of the battery module 100. As one example, if the accelerometer 370 and battery module 100 is oriented as in FIG. 1, the accelerometer 370 will provide one of six outputs that corresponds to the storage mode orientation. If the accelerometer 370 and battery module 100 is moved to another orientation (e.g. right side up), the accelerometer 370 will provide another of the six outputs that corresponds to the non-storage mode orientation. The batter control circuit configuration including the microprocessor 110 will execute according to system design and programming as described herein to maintain or change the operative state of the battery module 100 depending on the data received from the accelerometer 370.

A communications link to and from the battery is provided via a wired or wireless link and facilitates communications with other battery communication links in other battery modules 100 or with other external or remote devices. For example, the microprocessor 110 can be programmed to communicate battery module 100 status information computer systems based in the vehicle or to other external computing devices such as smartphones, tablets, or custom data acquisition modules. Status information from the battery module 100 may include but is not limited to minimum battery cell voltage, current consumption, error messages, or occurrences of over-current or over-voltage conditions. The communications link is also useful to establish and maintain communications between battery modules 101 that are deployed in parallel or series to augment power requirements or accomplish battery module power 100 redundancies. As illustrated the communications link can a wired 175 (e.g. I2C® bus) or a wireless 170 (e.g. Bluetooth®) technology. An application installable on a user's mobile computer or smart phone can communicate with the battery module 100 and program the microprocessor 110, or the accelerometer 370 (or the accelerometer 370 or the accelerometer 370 and gyroscope 400 combination) to recognize at least one physical orientation as the first operative state and at least another physical orientation as the second operative state. Finally, the battery module 100 includes a visual status indicator such as a multi-color LED 190 that is coupled to a port on the microprocessor 110 that indicates one or more statuses by the intermittent or steady display of several colors lit by the multi-color LED 190. Moreover, an accelerometer can be included to ensure that one or more battery module 100 operations are not initiated if the battery module 100 is not in an upright orientation.

The battery module 100 control circuit described enables embodiments of battery modules 100 that are capable of detecting physical orientations and maintaining or altering battery module 100 operational states depending on the physical orientation detected. As one example, a battery module 100 may be oriented in a first orientation for storage or transport and another orientation for standard battery module 100 use. The detection of the first orientation by the orientation detection and enablement circuit may cause the battery module 100 control circuit to enable/maintain the first operative state, which in preferred embodiments corresponds to a zero-power state. If the battery module 100 orientation detection and enablement circuit is subsequently installed into a vehicle in a different, second orientation (i.e. resting the housing bottom wall portion 23), the battery module 100 orientation detection and enablement circuit may cause the battery module 100 to automatically enter or enable the second operative state to permit vehicle starts; or may alternately merely enable the possibility of the second operative state and issue via a wireless link an instruction causing a prompt to vehicle electronics, or to an application installed on a user device, requesting confirming that the battery module 100 system programming should enable an operative state that allows for vehicle starts. Or alternatively, yet another different or alternate operative state that may be programmed or enabled may cause the battery module 100 to have a relatively low voltage and current that is insufficient to power external loads of significance (i.e. a vehicle electrical system during an engine start event) but that may still be sufficient to power smaller loads including microprocessors, memories, radios, or other vehicle accessory electronics that ordinarily use battery power to sustain settings or operation when the vehicle engine is not running.

Furthermore, the detection of two or more different and successive physical orientations may be programmed to be associated with events occurring after the battery module 100 has been installed into a vehicle or otherwise put to standard and intended use. As one example, a battery module 100 as described herein may be installed in a vehicle wherein system programming enables the detection of two or more different physical orientations, or two or more different physical orientations occurring during a certain lapsed time chosen by programming. In one example, system programming detecting physical orientation data associated with a first physical orientation followed by at least a second orientation may be associated with a towing event. It is contemplated that detection of the towing event could further include system programming to send an alert message to a user device, shut down the battery module 100 or vehicle, and/or enact an alarm. Yet another example entails the detection of two or more different and successive physical orientations, or alternatively, the inability to detect a single physical orientation, which could be associated in system configuration or programming to indicate a roll-over event. System programming within the battery module 100 could further use detection of the roll-over event to enter additional programmed or programmable states. Finally, the operational states of the battery module 100 may be programmed to correspond to one or more battery module 100 physical orientations as selected and programmed by a manufacturer, dealer, distributor, or an end user and are either preprogrammed in the factory or programmable from outside of the battery module 100 such as by a communications link comprising a wireless radio inside the battery module 100 that communicates with a wireless radio located outside of the battery module 100.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents and all such modifications that fall within the scope of the claims.

1. A control circuit for a power source in a housing, comprising:
a negative power terminal and a positive power terminal that each penetrate and conduct power through the housing;
a contactor having first and second contactor terminals and a contactor control terminal, one of the contactor terminals coupled between the power source and at least one of the negative or positive power terminals; and
an orientation detection and enablement circuit that includes a CPU and an orientation detection component, the orientation detection component selected from accelerometers, gyroscopes, and magnetometers or a combination thereof, the orientation detection component has an interrupt output and an orientation data output, wherein the housing is in a first orientation and the interrupt output produces an interrupt signal upon detection of the housing in a second orientation, and the CPU has an orientation data input and a contactor enable output, the CPU orientation data input coupled to the orientation data output and the contactor enable output coupled to the contactor control terminal;
wherein the first orientation and the second orientation have first and second operating states, respectively.

2. The control circuit in claim 1 wherein,
the CPU is programmed to toggle the contactor control terminal after confirmation that the orientation data output corresponds to the second orientation.

3. The control circuit in claim 1 wherein,
the CPU has a wake/sleep control input coupled to the interrupt output.

4. The control circuit in claim 3 wherein,
confirmation that data from the orientation data output corresponds to the second orientation is by comparison against data stored in memory or by mathematical operation or both.

5. The control circuit in claim 1 wherein,
the orientation detection and enablement circuit further comprises a voltage source switch with first and second terminals and a voltage source switch first control, a low power voltage source coupled to the voltage source switch first terminal, a CPU power input coupled to the voltage source switch second terminal, the voltage source switch first control coupled to the interrupt output and configured to close the voltage source switch if the orientation detection component detects the second orientation.

6. The control circuit in claim 5 wherein,
the voltage source switch further comprises a second control that is coupled to a CPU power interrupt output and the voltage source switch configured to open the voltage source switch based on the second control.

7. The control circuit in claim 6 wherein,
the CPU is programmed to electrically toggle the CPU power interrupt output if the data received on the orientation data output does not correspond to the second orientation.

8. The control circuit in claim 5 wherein,
the voltage source switch further comprises third and fourth terminals, the power source is coupled to the third terminal, the fourth terminal is coupled to a sensing circuit that is also coupled to at least one of the negative or positive power terminals.

9. The control circuit in claim 1 wherein,
orientation detection and enablement circuit comprises a gyroscope functionally coupled to the accelerometer and CPU.

10. The control circuit in claim 1 wherein,
first operating state corresponds to a negligible voltage potential between the negative power terminal and the positive power terminal and the second orientation corresponds to voltage potential of at least 70% of the power source.

11. The control circuit in claim 1 wherein,
first operating state corresponds to a negligible voltage potential between the negative power terminal and the positive power terminal and the second orientation corresponds to voltage potential of less than 70% of the power source.

12. The control circuit in claim 1 further comprising,
a charging regulator with a charging input coupled to the positive power terminal and a charging output coupled to the power source and a charging control input coupled to the CPU, the charging regulator configured to permit flow of current into the power source, but not from, the positive power terminal.

13. The control circuit in claim 1 wherein, the battery module in the first operating state cannot source power to loads external to the battery module, and the battery module in the second operating state can source power to loads external to the battery module.

14. The control circuit in claim 13 wherein,
the power sourced to loads external to the battery module in the second operating state is selected from least 70% and less than 65% of the power source.

15. The battery control circuit in claim 12 wherein,
the power source comprises a plurality of battery cells stacked to create an accumulated battery voltage.

16. A method of controlling a battery module when transitioning from a first orientation to a second orientation, comprising:
monitoring the orientation of the battery housing with an orientation detection component;
with the orientation detection component, detecting a change in the orientation of the battery housing in the first orientation and generating an interrupt signal;
with the interrupt signal, waking a CPU;
confirming that the battery housing is in the second orientation; and
closing a contactor coupled between at least one battery cell in the battery module and either a positive or negative terminal of the battery module.

17. The method of claim 16 wherein,
waking a CPU comprises closing a switch that couples a low power source to a power input of the CPU.

18. The method of claim 14 wherein,
waking a CPU comprises configuring the CPU to transition from a low power state to a higher power state based on receipt of the interrupt signal.

19. The method of claim 14 wherein,
waking a CPU comprises configuring the CPU to transition from a low power state to a higher power state based on intervals set within the CPU.

20. The method of claim 16 further comprising,
sensing the voltage or current conditions at either the positive or negative terminal of the battery module.
